(19) United States
(12) Patent Application Publication
(10) Pub. No.: US 2012/0303570 A1
(43) Pub. Date: Nov. 29, 2012

(54) SYSTEM FOR AND METHOD OF PARSING AN ELECTRONIC MAIL

(75) Inventor: Ira C. Stevens, III, Quakertown, PA (US)

(73) Assignee: VERIZON PATENT AND LICENSING, INC., Basking Ridge, NJ (US)

(21) Appl. No.: 13/117,316

(22) Filed: May 27, 2011

(51) Int. Cl. G06N 5/02

(52) U.S. Cl. 706/50

(57) ABSTRACT

A system for and method of parsing an electronic mail for scheduling a calendar appointment is presented. The system and method for parsing information from an electronic mail for scheduling a calendar appointment. The method may include receiving an electronic mail comprising observations for scheduling a calendar appointment and decoding, via at least one computer processor, the observations into symbol vectors. The method may also include classifying the symbol vectors based at least in part on a statistical probability and converting the observations based at least in part on a token. The method may further include outputting a dictionary result list based at least in part on the statistical probability, wherein the dictionary result list comprises one or more token name-value pairs.

### BACKGROUND INFORMATION

Electronic mail provides a method of sending message from an author to one or more recipients. Today, electronic mail is becoming one of the most popular forms of communication. Often, electronic mail may be used to schedule calendar appointments between an author and one or more recipients. An electronic mail used to schedule calendar appointments may include a description, a location (e.g., a building or a room number), a telephone number, a personal identification number, and a passcode. The electronic mail used to schedule calendar appointments may be written in a human readable, in one language or another, and formatted freeform or according to the users regional, culture or personal preferences. Typically, a parser of an electronic mail to schedule calendar appointments is constrained to a specific set of definitions and rules that cover a limited set of formatting structures, languages, and keywords. The ambiguous nature of the text of the electronic mail makes identification of the contents in the electronic mail difficult and inaccurate. Thus, a simple and accurate parsing system is needed in order to identify contents contained in an electronic mail for scheduling a calendar appointment.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a block diagram of a hardware component of the intelligent parser system of a particular embodiment; and

FIG. 3 is a flowchart illustrating the functionality for parsing information from an electronic mail for scheduling a calendar appointment a particular embodiment.

### DETAILED DESCRIPTION OF PREFERRED EMBODIMENTS

An embodiment provides a system and method for parsing an electronic mail for scheduling a calendar appointment. A parsing operation may be defined as a syntactic analysis of text made of a sequence of tokens (e.g., words, numerals, or symbols) to determine a grammatical structure. A token may be defined as a string of characters, categorized according to the rules as a symbol. For example, an intelligent parsing system may identify various sections of an electronic mail for scheduling a calendar appointment. The intelligent parsing system may identify a subject section, a location section, an agenda section, a body section, and other sections of the electronic mail. The intelligent parsing system may parse through various sections of an electronic mail to identify a telephone number (TN) and a personal identification or access number (PIN) associated with an electronic mail for scheduling a calendar appointment.

The intelligent parsing system may improve an accuracy of parsing operation of various section of an electronic mail by learning from feedback results. For example, the intelligent parsing system may comprise a feedback mechanism that may receive feedback results from previous parsing operation in order to improve future parsing operations. In a particular embodiment, the feedback mechanism may provide and track the format of electronic mails of previous parsing operations in order to improve the accuracy of the intelligent parsing system when similar format is encountered in future parsing operations. In another embodiment, the feedback mechanism may provide a correctional feedback to the intelligent parsing system when incorrect parsing operations occur.

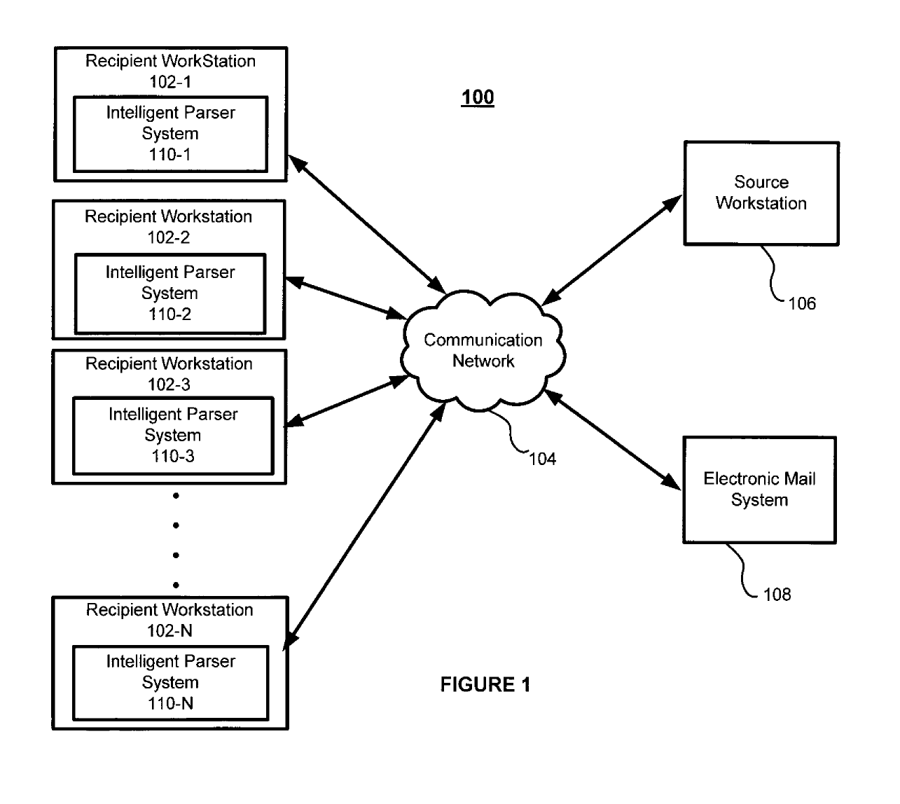

FIG. 1 is a schematic diagram illustrating a system according to particular embodiments. As illustrated in FIG. 1, the system 100 for parsing various sections of an electronic mail to schedule a calendar appoint may include a plurality of intelligent parsing systems 102(1-N) installed or downloaded to a plurality of recipient workstations 110(1-N) associated with users. The plurality of intelligent parser system 102(1-N) may be coupled to a source workstation 106 via a communication network 104. The plurality of intelligent parser systems 102(1-N) may be also coupled to an electronic mail system 108 via the communication network 104, The source workstation 106 may send an electronic mail to one or more recipient workstations 110(1-N) to schedule a calendar appointment. In a particular embodiment, the source workstation 106 may send an electronic mail to one or more recipient workstations 110(1-N) directly via the communication network 104 to schedule a calendar appointment. In another embodiment, the source workstation 106 may send an electronic mail to one or more recipient workstations 110(1-N) via the electronic mail system 108 and the communication network 104 to schedule a calendar appointment.

The intelligent parser system 102 may parse various sections of an electronic mail for scheduling a calendar appointment. The electronic mail for scheduling a calendar appointment may include texts, numerals, and symbols composed in a human readable form or language. The intelligent parser system 102 may receive information (e.g., texts, numerals, and symbols) from various sections of an electronic mail and parse the information to identify telephone number (TN), a personal identification or access number (PIN), description information, location information, timing information, and other information associated with a calendar appointment. In a particular embodiment, the intelligent parser system 102 may receive information from a location section of an electronic mail and parse the information to identify a telephone number (TN) and a personal identification or access number (PIN) associated with a calendar appointment.

The intelligent parser system 102 may receive feedback results in order to improve future parsing operations. For example, the intelligent parser system 102 may maintain a database of grammatical structures from previous correctly parsed operation. When similar grammatical structures are encountered in the future, the intelligent parser system 102 may utilize stored grammatical structures to perform the parsing operation. The intelligent parser system 102 may receive correctional feedbacks when incorrect parsing operation is performed. The intelligent parser system 102 may learn from correctional feedbacks to correct a grammatical structure identified in the incorrect parsing operation. The corrected grammatical structure may be stored by the intelligent parser system 102 for future parsing operations.

The plurality of recipient workstations 110(1-N) hosting the plurality of intelligent parser systems 102(1-N) may be a computer, a personal computer, a laptop, a cellular communication device, a workstation, a mobile device (e.g., smart phone), a phone, a handheld PC, a personal digital assistant (PDA), a thin system, a fat system, a network appliance, a network device (e.g., Tablets), an Internet browser, or other any other device that may be in communication with the source workstation 106 and the electronic mail system 108 via the communication network 104.

The communication network 104 may couple the plurality of recipient workstations 110(1-N) to the source workstation 106 and the electronic mail system 108. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 104 may include, without limitation, telephone line, fiber optics, IEEE Ethernet 802.3, wide area network (WAN), local area network (LAN), global network such as the Internet, or long term evolution (LTE) mobile network technology. The communication network 104 may support an Internet network, a wireless communication network, a cellular network, or the like, or any combination thereof.

The communication network 104 may further include one, or any number of types of networks mentioned above operating as a stand-alone network or in cooperation with each other. The communication network 104 may include one, or any number of networks that may enable transmission of data via the transport layer security (TLS) protocol or the secure sockets layer (SSL) protocol. Although the communication network 104 is depicted as one network, it should be appreciated that according to one or more embodiments, the communication network 104 may comprise a plurality of interconnected networks, such as, for example, a service provider network, the Internet, a broadcaster's network, a cable television network, corporate networks, and home networks.

The source workstation 106 may be similar to the plurality of recipient workstations 110(1-N). For example, the source workstation 106 may be a computer, a personal computer, a laptop, a cellular communication device, a workstation, a mobile device (e.g., smart phone), a phone, a handheld PC, a personal digital assistant (PDA), a thin system, a fat system, a network appliance, a network device (e.g., Tablets), an Internet browser, or other any other device that may be in communication with the plurality of recipient workstations 110(1-N) and the electronic mail system 108 via the communication network 104.

The electronic mail system 108 may include one or more servers. For example, the electronic mail system 108 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, LINUX server, or other independent server to send electronic mails to a plurality of recipient workstations 110(1-N). Also, the electronic mail system 108 may include one or more Internet Protocol (IP) network server or public switch telephone network (PSTN) server.

The electronic mail system 108 may include one or more storage devices including, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

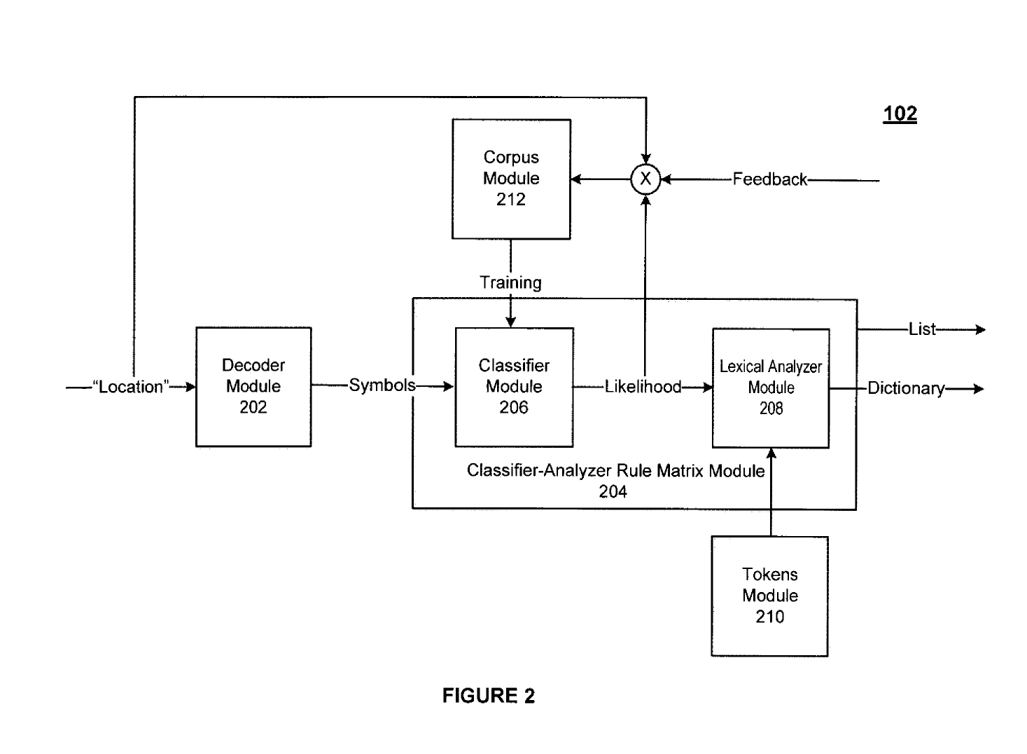

FIG. 2 is a block diagram of a hardware component of the intelligent parser system 102 of a particular embodiment. The intelligent parser system 102 may include a decoder module 202, a classifier-analyzer rule matrix module 204 comprising a classifier module 206 and a lexical analyzer module 208, a tokens module 210, or a corpus module 212. It is noted that the modules 202, 204, 206, 208, 210, and 212 are exemplary and the functions performed by one or more of the modules may be combined with that performed by other modules. The functions described herein as being performed by the modules 202, 204, 206, 208, 210, and 212 also may be separated and may be located or performed by other modules. Moreover, the modules 202, 204, 206, 208, 210, and 212 may be implemented at other devices of the intelligent parser system 102 for parsing an electronic mail for scheduling a calendar appointment (e.g., the communication network 104, the source workstations 106, and the electronic mail system 108).

The decoder module 202 may comprise at least one computer processor for converting a sequence of characters, texts, or numerals into symbols recognized by the classifier module 206. In a particular embodiment, the decoder module 202 may be a unicode decoder using modulus 256 of each of the 16-bit characters. The decoder module 202 may output a variable length symbol vector based at least in part on a length of the sequent of characters, texts, or numerals from various sections of an electronic mail for scheduling a calendar appointment. In a particular embodiment, the decoder module 202 may decode information from various sections of an electronic mail to schedule a calendar appointment into a 256 symbol vector. The decoder module 202 may trim extra spaces or tab characters from the information and convert the sequence of characters, texts, or numerals into symbols using modulus 256.

The previously known classifications may be provided by the corpus module 212 to the classifier module 206. The corpus module 212 may receive an observation or a text that may be a segment of information of various sections of an electronic mail to schedule a calendar appointment. The corpus module 212 may determine text of an observation by a predetermined segmentation rules (e.g., line-by-line segmentation). The corpus module 212 may classify observations based at least in part on a parser rule permutation. The corpus module 212 may classify a set of observations to a class corpus based at least in part on a correlation of a parser rule permutation of the set of observations. The corpus module 212 may comprise a plurality of class corpora to form a parser corpus. For example, a user may establish the corpus module 212 by providing sample observations to the corpus module 212. The corpus module 212 may classify the sample observations into the plurality of class corpora based at least in part on a correlation of a parser rule permutation to a class corpus. The size of the class corpus may be limited and incorrect classification of sample observations may be deleted.

The classifier-analyzer rule matrix module 204 may comprise a classifier module 206 and a lexical analyzer module 208. The classifier module 206 may comprise at least one computer processor to classify symbol vectors provided by the decoder module 202. For example, the decoder module 202 may decode observations (e.g., a text that may be a segment of information of various sections of an electronic mail to schedule a calendar appointment) into symbol vectors and provide the symbol vectors to the classifier module 206. The classifier module 206 may classify or differentiate symbol vectors provided by the decoder module 202 based at least in part on relative probability or previously known classifications. For example, the classifier module 206 may classify symbol vectors using a generalization of a mixture statistical probability model with hidden variables which control the mixture of components to be selected for each observation. In a particular embodiment, the classifier module 206 may classify symbol vectors via a statistical probability model. In a particular embodiment, the classifier module 206 may use a hidden Markov model (HMM) using Baum-Welch algorithms to classify symbol vectors provided by the decoder module 202. The hidden Markov model (HMM) may utilize a predetermined number of states and number of discrete symbols. The number of predetermined number of states may be determined based at least in part on a mean number of symbols expected per observation. The number of predetermined number of discrete symbols may be determined based at least in part by the number of relevant symbols of the computer or electronic mail character set. The classifier module 206 may recognize symbol vectors using a forward algorithm. In an particular embodiment, a forward algorithm may be the Viterbi algorithm.

The classifier module 206 may classify or differentiate symbol vectors based at least in part on a relative probability. For example, the classifier module 206 may classify symbol vectors to a state based at least in part on a maximum probability distribution. In a particular embodiment, the classifier module 206 may classify symbol vectors into four different states. For example, the first state may have a probability distribution of 10%, the second state may have a probability distribution of 15%, the third state may have a probability distribution of 25%, and the fourth state may have a probability distribution of 50%. The classifier module 206 may classify symbol vector to the fourth state based at least in part on the probability distribution of the fourth state.

The classifier module 206 may classify or differentiate symbol vector based at least in part on previously known classifications. For example, the classifier module 206 may store format (e.g., grammatical structure or syntax) of previous classified symbol vectors during previous parsing operations in a database. The classifier module 206 may search the stored format of previously classified symbol vectors to identify a similar format as the symbol vector of the current parsing operation. For example, the classifier module 206 may compare and contrast the stored format of previously classified symbol vectors with the format of the symbol vector of the current parsing operation. The classifier module 206 may classify the symbol vector of the current parsing operation based at least in part on a similar stored format of a previously classified symbol vector. The classifier module 206 may classify or differentiate a symbol vector by accessing the corpus module 212 comprising previously known classifications (e.g., class corpus) of corpus module 212. For example, the classifier module 206 may classify the symbol vector based at least in part on a class corpus of the corpus module 212. The classifier module 206 may identify class corpus similar to the symbol vector and classify the symbol vector based on the identified class corpus.

The lexical analyzer module 208 may comprise at least one computer processor to convert (or tokenize) observations from various sections of an electronic mail to schedule a calendar appointment into a series of tokens. The lexical analyzer module 208 may convert observations (e.g., using token definitions) from left to right while ignoring unrecognizable texts, numerals, or symbols in the observations. The lexical analyzer module 208 may convert observations using parser logic (e.g., Backus-Naur Form). The parser logic used by the lexical analyzer module 208 may be:

```
  <observation> ::= <left-hand> <right-hand>
<left-hand> ::= {<contextual-text>} [<token>]
    <right-hand> ::= [<left-hand>] <eol>
```

The lexical analyzer module 208 may assume that an observation may comprise at least two portions, at least one left portion and a right portion. The at least one left portion of an observation may comprise optional contextual text followed by a token. The right portion of an observation may comprise optional contextual text followed by a token and an end-of-line delimiter. In a particular embodiment, an observation may comprise a plurality of left portions and a right portion. The lexical analyzer module 208 may analyze an observation based at least in part on a received token from the tokens module 210. The lexical analyzer module 208 may perform a left to right expression search based on the received token from the tokens module 210. The lexical analyzer module 208 may search perform a left to right expression search for each of the tokens provided by the tokens module 210. The lexical analyzer module 208 may remove contextual-text and extract token value before performing the left to right expression search for the next token. For example, the lexical analyzer module 208 may convert an observation based at least in part on a telephone number (TN) and a personal identification or access number (PIN) token. After converting observations into a series tokens, the lexical analyzer module 208 may output a dictionary list for further pruning. For example, the lexical analyzer module 208 may output a dictionary containing token name-value pairs order by probability. The user of the intelligent parser system 102 may parse the token to derive an expected behavior.

Dictionary list pruning may remove illogical or irrelevant token combinations from a list of resulting dictionaries. For example, the dictionary list pruning may remove an illogical or irrelevant token if one of the following conditions is met: (1) if two or more personal identification or access number (PIN) are defined; (2) if a telephone number (TN) or a personal identification or access number (PIN) value is missing (e.g., observation do not have the required number of tokens); or (3) if more telephone numbers (TN) or personal identification or access numbers (PIN) are available (e.g., observation has more than required number of tokens).

The tokens module 210 may provide a plurality of tokens to the lexical analyzer module 208. For example, tokens module 210 may provide a token associated with each of the observations. The tokens module 210 may provide a token of a telephone number (TN) and a token of a personal identification or access number (PIN) to the lexical analyzer module 208. Other tokens may be provided by the tokens module 210, for example, a description token, a building token, a room number token, a passcode token, a schedule token, or a timing token. The tokens module 210 may sequentially provide tokens to the lexical analyzer module 208. The tokens module 210 may provide a token that may comprise multiple regular expression definitions. Regular expression may be defined as a concise and flexible means for matching strings of text, such as particular characters, words, or patterns of characters. In the event that a token has multiple regular expression definitions, each regular expression definition may be applied until a regular expression definition may produce a value or no value is produced after applying all the regular expression definitions. One regular expression definition may have a higher precedence than the next regular expression definition. For example:

| | |
|---|---|
| <tn> = “((\(?(\d{3})(\)?)(-\|.\|\s)?))+(\d{4})” | // TN top precedence |
| <tn> = “((\(?(\d{3})(\)?)(-\|.\|\s)?))+([A-Za-z]{4}}” | // TN next precedence |
| <pin> = “((\d)+(-\|.\|\s)?)+(#)?” | // PIN top precedence |

The classifier-analyzer rule matrix module 204 comprising the classifier module 206 and the lexical analyzer module 208 may generate classifier-analyzer rule matrices including all permutations of a parser for one or more tokens. The classifier-analyzer rule matrices may also include a maximum allowable number of tokens per observation of various section of an electronic mail to schedule a calendar appointment. The number of permutations may be determined by the following formula:

$$Number of Permuations = {\sum }_{m = 1 … K} {n}^{m} .$$

In the above formula, n may be defined a number of tokens, m may be defined as a maximum allowable number-of-tokens per observation. The number of permutations will rise exponentially as increase in the maximum allowable number-of-tokens per observation. Thus, a change in an observation (e.g., segmenting an observation) or a number of tokens may not affect the number of permutations as much as the maximum allowable number-of-tokens per observation.

In a particular embodiment, the classifier-analyzer matrix module 204 may generate classifier-analyzer rule matrices that may identify two tokens and two maximum allowable number-of-tokens per observation. The classifier-analyzer matrix module 204 may generate the following matrices (e.g., Matrix A and Matrix B) including classifiers for each token sequence combination:

| A | |
|---|---|
| TN | HMMA1 |
| PIN | HMMA2 |

| B | TN | PIN |
|---|---|---|
| TN | HMMB1 | HMMB2 |
| PIN | HMMB3 | HMMB4 |

The row title of the matrices may denote a left-hand token while the column title may denote a right-hand token. Matrix A may demonstrate a single dictionary result, while Matrix B may demonstrate a double dictionary result. For example, in Matrix A, HMMA1 may denote a single telephone number (TN) dictionary result and HMMA2 may denote a single personal identification or access number (PIN) dictionary result. In Matrix B, HMMB1 may denote a double telephone number (TN) dictionary results, HMMB2 may denote a telephone number (TN) dictionary result followed by a personal identification or access number (PIN) dictionary result, HMMB3 may denote a personal identification or access number (PIN) dictionary result followed by a telephone number (TN) dictionary result, and HMMB4 may denote a double personal identification or access number (PIN) dictionary results.

In a particular embodiment, an observation of “Bridge 877-267-9292, Passcode 877/867-9292” may be received at classifier-analyzer matrix module 204. The classifier-analyzer matrix module 204 may generate the following matrices (e.g., Matrix A and Matrix B) including classifier for each token sequence combination:

| A | |
|---|---|
| TN | 0.16 |
| PIN | 0.16 |

| B | TN | PIN |
|---|---|---|
| TN | 0.16 | 0.16 |
| PIN | 0.16 | 0.16 |

The classifier for each token sequence combination may be equally weighted. For example, classifier-analyzer matrix module 204 may determine that the probability of a single telephone number (TN) dictionary result is 16.6%, the probability of a single personal identification or access number (PIN) dictionary result is 16.6%, the probability of a double telephone number (TN) dictionary results is 16.6%, the probability of a telephone number (TN) dictionary result followed by a personal identification or access number (PIN) dictionary result is 16.6%, the probability of a personal identification or access number (PIN) dictionary result followed by a telephone number (TN) dictionary result is 16.6%, and the probability of a double personal identification or access number (PIN) dictionary results is 16.6%.

The dictionary result list may be subjected to dictionary list pruning. For example, the classifier-analyzer matrix module 204 may received two tokens for the observation and thus two dictionary results are required. The classifier-analyzer matrix module 204 may eliminate the results from Matrix A because Matrix A contains single dictionary result. After eliminating the illogical or irrelevant dictionary results, the classifier-analyzer matrix module 204 may reformat the Matrix B as follows:

| B | TN | PIN |
|---|---|---|
| TN | 0.25 | 0.25 |
| PIN | 0.25 | 0.25 |

After pruning the dictionary result list, the classifier-analyzer matrix module 204 may determine that the probability of a double telephone number (TN) dictionary results is 25%, the probability of a telephone number (TN) dictionary result followed by a personal identification or access number (PIN) dictionary result is 25%, the probability of a personal identification or access number (PIN) dictionary result followed by a telephone number (TN) dictionary result is 25%, and the probability of a double personal identification or access number (PIN) dictionary results is 25%.

The classifier-analyzer matrix module 204 may present the Matrix B to a user of the intelligent parser system 102 for verification. For example, the user may select a correct dictionary result from Matrix B. The user may select that the permutation of a telephone number (TN) dictionary result followed by a personal identification or access number (PIN) dictionary result is the correct permutation. The selection by the user may feedback to the corpus module 212 to classify in a class corpus. When a subsequent observation of “Dial 278-662-9393, Pass 278-662-9393” is received at the classifier-analyzer matrix module 204, the classifier-analyzer matrix module 204 may generate the following matrices (e.g., Matrix A and Matrix B) based at least in part on the class corpus established in corpus module 212 by the previous parsing operation:

| A | |
|---|---|
| TN | 0.15 |
| PIN | 0.15 |

| B | TN | PIN |
|---|---|---|
| TN | 0.15 | 0.21 |
| PIN | 0.15 | 0.15 |

As indicated in Matrix B, the permutation for a telephone number (TN) dictionary result followed by a personal identification or access number (PIN) dictionary result is higher has a higher probability than other permutations based at least in part on the class corpus established in the corpus module 212. Thus, the accuracy of the classifier-analyzer rule matrix module 204 may be improved from past parsing operations.

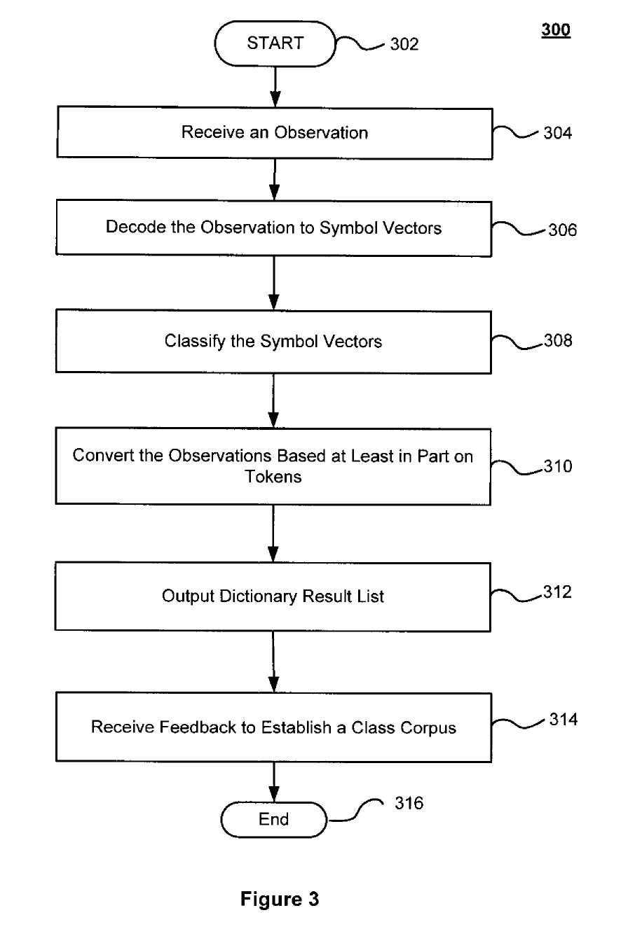

FIG. 3 is a flowchart illustrating the functionality for parsing information from an electronic mail for scheduling a calendar appointment of a particular embodiment. This exemplary method 300 may be provided by way of example, as there are a variety of ways to carry out the method. The method 300 shown in FIG. 3 can be executed or otherwise performed by one or a combination of various systems. The method 300 is described below may be carried out by the system and network shown in FIGS. 1 and 2, by way of example, and various elements of the system and network are referenced in explaining the example method of FIG. 3. Each block shown in FIG. 3 represents one or more processes, methods or subroutines carried out in exemplary method 300. Referring to FIG. 3, exemplary method 300 may begin at block 302.

At block 302, the method 300 for parsing information from an electronic mail for scheduling a calendar appointment may begin.

At block 304, an electronic mail for scheduling a calendar appointment may be received at the recipient workstation 110. For example, the electronic mail for scheduling a calendar appointment may include at least one section having a plurality of observations. In a particular embodiment, an electronic mail for scheduling a calendar appointment may include a location section having at least one observation. The recipient workstation 110 may provide the electronic mail for scheduling a calendar appointment to the decoder module 202 of the intelligent parser system 102. The decoder module 202 may receive one or more observations of a section of the electronic mail for scheduling a calendar appointment. After receiving an observation at the decoder module 202, the method 300 may proceed to block 306.

At block 306, the observation may be decoded. The decoder module 202 may decode the observation into a symbol vector. For example, the decoder module 202 may decode an observation into a sequence of characters, texts, or numerals into symbols recognized by the classifier module 206. The decoder module 202 may output a variable length symbol vector based at least in part on a length of the sequent of characters, texts, or numerals of the observation. The decoder module 202 may trim extra spaces or tab characters from the observation and decode the sequence of characters, texts, or numerals into symbol vectors. The decoder module 202 may output symbol vectors to the classifier modules 206. After decoding the observation, the method 300 may proceed to block 308.

At block 308, classifying the symbol vectors. The classifier module 206 may classify symbol vectors. The classifier module 206 may classify or differentiate symbol vectors provided by the decoder module 202 based at least in part on relative probability or previously known classifications. In a particular embodiment, the classifier module 206 may classify or differentiate symbol vectors based at least in part on a relative probability. For example, the classifier module 206 may classify symbol vectors to a state based at least in part on a maximum probability distribution. In a particular embodiment, the classifier module 206 may classify symbol vectors into four different states. For example, the first state may have a probability distribution of 10%, the second state may have a probability distribution of 15%, the third state may have a probability distribution of 25%, and the fourth state may have a probability distribution of 50%. The classifier module 206 may classify symbol vector to the fourth state based at least in part on the probability distribution of the fourth state.

In another embodiment, the classifier module 206 may classify or differentiate symbol vector based at least in part on previously known classifications. For example, the classifier module 206 may store format (e.g., grammatical structure or syntax) of previous classified symbol vectors during previous parsing operations in a database. The classifier module 206 may search the stored format of previously classified symbol vectors to identify a similar format as the symbol vector of the current parsing operation. For example, the classifier module 206 may compare and contrast the stored format of previously classified symbol vectors with the format of the symbol vector of the current parsing operation. The classifier module 206 may classify or differentiate symbol vector by accessing the corpus module 212 comprising previously known classifications (e.g., class corpus) of corpus module 212. For example, the classifier module 206 may classify the symbol vector based at least in part on a class corpus of the corpus module 212. The classifier module 206 may identify class corpus similar to the symbol vector and classify the symbol vector based on the identified class corpus. After classifying the symbol vectors, the method 300 may proceed to block 310.

At block 310, the observation may be converted based at least in part on a token. The tokens module 210 may provide a token to the lexical analyzer module 208. The lexical analyzer module 208 may convert the observation from left to right while ignoring unrecognizable texts, numerals, or symbols in the observations based at least in part on the token. The lexical analyzer module 208 may convert observations using parser logic (e.g., Backus-Naur Form). The lexical analyzer module 208 may assume that an observation may comprise at least two portions, at least one left portion and a right portion. The at least one left portion of an observation may comprise optional contextual text followed by a token. The right portion of an observation may comprise optional contextual text followed by a token and an end-of-line delimiter.

The lexical analyzer module 208 may perform a left to right expression search based on the received token from the tokens module 210. The lexical analyzer module 208 may search perform a left to right expression search for each of the tokens provided by the tokens module 210. The lexical analyzer module 208 may extract token value before performing the left to right expression search for the next token. For example, the lexical analyzer module 208 may convert an observation based at least in part on a telephone number (TN) and a personal identification or access number (PIN) token.

in a particular embodiment, an observation may be “please use the bridge 877-267-1232 and passcode 877-267-1232.” The lexical analyzer module 208 output a list of dictionary results having a probability of accuracy. The lexical analyzer module 208 may output the following matrix:

| | TN | PIN |
|---|---|---|
| TN | 0.25 | 0.25 |
| PIN | 0.25 | 0.25 |

For example, the matrix illustrates that the probability of a double telephone number (TN) dictionary results is 25%, the probability of a telephone number (TN) dictionary result followed by a personal identification or access number (PIN) dictionary result is 25%, the probability of a personal identification or access number (PIN) dictionary result followed by a telephone number (TN) dictionary result is 25%, and the probability of a double personal identification or access number (PIN) dictionary results is 25%. After converting the observations based at least in part on tokens, the method 300 may proceed to block 312.

At block 312, the dictionary result list may be outputted. The lexical analyzer module 208 may be output the dictionary result list to the user. For example, the lexical analyzer module 208 may remove illogical or irrelevant token combinations from the dictionary result list. For example, the lexical analyzer module 208 may remove an illogical or irrelevant token if one of the following conditions is met: (1) if two or more personal identification or access number (PIN) are defined; (2) if a telephone number (TN) or a personal identification or access number (PIN) value is missing (e.g., observation do not have the required number of tokens); or (3) if more telephone numbers (TN) or personal identification or access numbers (PIN) are available (e.g., observation has more than required number of tokens). The lexical analyzer module 208 may output the dictionary result list to the user after removing illogical or irrelevant token combinations from the dictionary result list. After outputting dictionary result list, the method 300 may proceed to block 314.

At block 314, receiving a feedback to establish a class corpus. The corpus module 212 may receive feedback to establish a class corpus. The feedback may be provided by a user selecting a dictionary result from the dictionary result list provided to the user. In another embodiment, the feedback may be automatically provided by the lexical analyzer module 208. For example, the corpus module 212 may receive feedback provided by a user or the intelligent parser system 102. The corpus module 212 may receive feedback to establish a class corpus for future parsing operation. The corpus module 212 may comprise a plurality of class corpora to form a parser corpus. For example, the feedback may train the corpus module 212 by providing previously parsed observations to the corpus module 212. The corpus module 212 may classify the previously parsed observations into the plurality of class corpora based at least in part on a correlation probability to a class corpus. The size of the class corpus may be limited and incorrect classification of sample observations may be deleted. The classifier module 206 may access the class corpus of the corpus module 212 to classify the symbol vectors.

In a particular embodiment, when a subsequent observation of “Dial bridge 266-243-3993, passcode 882-9393,” is received at the intelligent parser system 102, the intelligent parser system 102 may output the following matrix of based at least in part on previously established corpus:

| | TN | PIN |
|---|---|---|
| TN | 0.20 | 0.40 |
| PIN | 0.20 | 0.20 |

The matrix illustrates that the probability of a double telephone number (TN) dictionary results is 20%, the probability of a telephone number (TN) dictionary result followed by a personal identification or access number (PIN) dictionary result is 40%, the probability of a personal identification or access number (PIN) dictionary result followed by a telephone number (TN) dictionary result is 20%, and the probability of a double personal identification or access number (PIN) dictionary results is 20%. The probability of a telephone number (TN) dictionary result followed by a personal identification or access number (PIN) dictionary result may be increased to 40% because of previously established class corpus. After receiving feedback to establish a class corpus, the method 300 may proceed to block 316.

At block 316, the method for parsing information from an electronic mail for scheduling a calendar appointment may end.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
receiving an electronic mail comprising observations for scheduling a calendar appointment;
decoding, via at least one computer processor, the observations into symbol vectors;
classifying the symbol vectors based at least in part on a statistical probability;
converting the observations based at least in part on a token; and
outputting a dictionary result list based at least in part on the statistical probability, wherein the dictionary result list comprises one or more token name-value pairs.

2. The method of claim 1, wherein the symbol vectors are variable symbol vectors having a length based at least in part on a length of the observations.

3. The method of claim 1, wherein decoding the observations into symbol vectors comprises trimming at least one of extra spaces and tab characters from the observations.

4. The method of claim 1, wherein the symbol vectors are classified using a generalization of a mixture statistical probability model with hidden variables which control the mixture of components to be selected for the observations.

5. The method of claim 1, the statistical probability of the symbol vectors is determined based at least in part on previous classified symbol vectors.

6. The method of claim 1, wherein classifying the symbol vectors comprises accessing previously known class corpus.

7. The method of claim 1, wherein the observations is converted from left to right while ignoring unrecognizable texts, numerals, or symbols in the observations.

8. The method of claim 1, wherein converting the observations comprises assuming that the observations comprise at least one left portion and a right portion.

9. The method of claim 8, wherein the at least one left portion comprises optional contextual text followed by the token.

10. The method of claim 10, wherein the right portion comprises optional contextual text followed by the token and an end-of-line delimiter.

11. The method of claim 8, wherein converting the observation comprises performing a left to right expression search based on the token.

12. The method of claim 1, wherein outputting a dictionary result list comprises removing illogical or irrelevant dictionary results from the dictionary result list.

13. The method of claim 1, further comprising receiving feedback to establish a class corpus.

14. The method of claim 13, wherein the class corpus comprises a set of observations based at least in part on a correlation of probability.

15. A non-transitory computer readable media comprising code to perform the steps of the method of claim 1.

16. A system, comprising:
a decoder module comprising at least one computer processor configured to receive an electronic mail comprising observations for scheduling a calendar appointment and decode the observations into symbol vectors;
a classifying module configured to classify the symbol vectors based at least in part on a statistical probability; and
a lexical analyzer module comprising at least one computer processor configured to convert the observations based at least in part on a token and output a dictionary result list based at least in part on the statistical probability, wherein the dictionary result list comprises one or more token name-value pairs.

17. The system of claim 16, further comprising a corpus module configured to establish a plurality of class corpora.

18. The system of claim 16, further comprising a tokens module configured to provide the token to the lexical analyzer module.

19. The system of claim 16, wherein the classifier module uses a hidden Markov model (HMM) using Baum-Welch algorithms to classify the symbol vectors.

20. The system of claim 16, wherein the lexical analyzer module converts the observations using Backus-Naur Form parser logic.
